(19) United States
(12) Patent Application Publication
(10) Pub. No.: US 2013/0235012 A1
(43) Pub. Date: Sep. 12, 2013

(54) LIQUID CRYSTAL DISPLAY

(71) Applicant: YI-ZHONG SHEU, Tu-Cheng (TW)

(72) Inventor: YI-ZHONG SHEU, Tu-Cheng (TW)

(73) Assignee: HON HAI PRECISION INDUSTRY CO., LTD., Tu-Cheng (TW)

(21) Appl. No.: 13/523,901

(22) Filed: Jun. 15, 2012

(30) Foreign Application Priority Data
Mar. 8, 2012 (TW) 101107974

(51) Int. Cl. G09G 5/00; G09G 3/36

(52) U.S. Cl. 345/211; 345/204; 345/87

(57) ABSTRACT

A liquid crystal display (LCD) includes an LCD panel, a circuit module, a driving module, and a signal transmitting module. The circuit module outputs electrical driving signals. The driving module is connected to the LCD panel and drives the LCD panel to display images according to the driving signals. The signal transmitting module includes a laser emitter, an optical waveguide, and a laser receiver. The laser emitter is connected between the circuit module and the optical waveguide and converts the electrical driving signals to optical signals. The laser receiver is connected between the optical waveguide and the driving module and recovers and reconverts the optical signals into driving signals.

### BACKGROUND

1. Technical Field

The present disclosure relates to liquid crystal displays (LCDs) and, particularly, to an LCD with increased image quality.

2. Description of Related Art

An LCD system may include an LCD panel, a driving module, a circuit board, and a controlling chip. The driving module is for driving the LCD panel to display an image. The controlling chip is mounted on the circuit board. The circuit board supplies power to the driving module, and the controlling chip outputs signals to the driving module. The controlling chip may be connected to the driving module with copper wires. As a result, the signals to the driving module may experience interference from parasitic capacitances formed between the copper wires, which may degrade the image displayed on the LCD panel.

Therefore, it is desirable to provide an LCD, which can overcome the limitations described.

### BRIEF DESCRIPTION OF THE DRAWINGS

FIG. 1 is a function block of an LCD in accordance with a first exemplary embodiment.

FIG. 2 is a function block of an LCD in accordance with a second exemplary embodiment.

### DETAILED DESCRIPTION

Embodiments of the disclosure will be described with reference to the drawings.

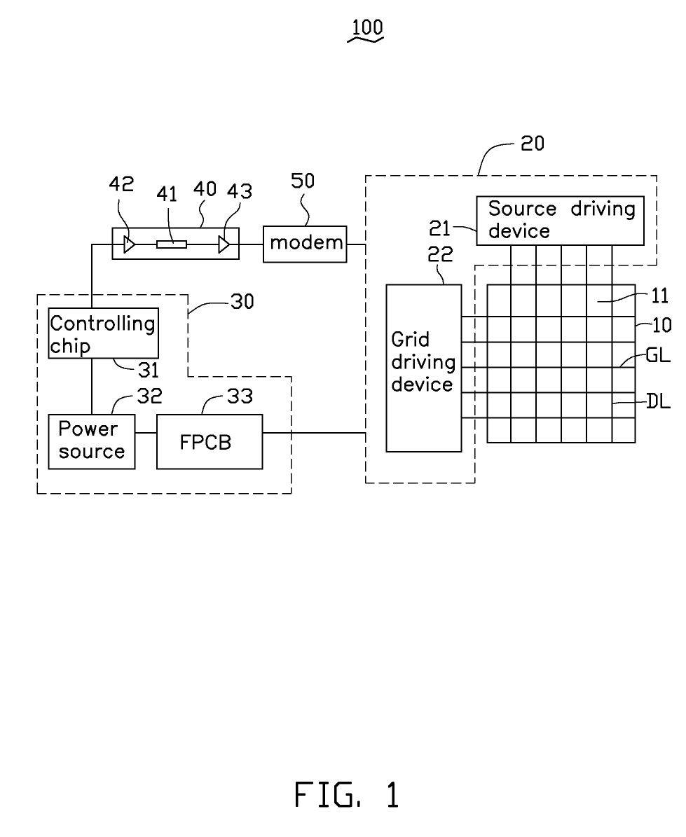

Referring to FIG. 1, an LCD 100, according to a first exemplary embodiment, includes an LCD panel 10, a driving module 20, a circuit module 30, a signal transmitting module 40, and a modem 50.

The LCD panel 10 includes a number of liquid crystal units 11, a number of gate lines GL, and a number of data lines DL. The liquid crystal units 11 are arranged in an array. The liquid crystal units 11 arranged in one row are connected to one gate line GL, and the liquid crystal units 11 arranged in one column are connected to one date line DL. The liquid crystal units 11 are turned on and off by signals from the gate lines GL and the data lines DL.

The driving module 20 includes a source driving device 21 and a grid driving device 22. The source driving device 21 is connected to the data lines DL and configured for outputting signals to the data lines DL. The grid driving device 22 is connected to the gate lines GL and configured for outputting signals to the gate lines GL.

The circuit module 30 includes a controlling chip 31, a power source 32, and a flexible printed circuit board (FPCB) 33. The controlling chip 31 is configured for receiving video signals and outputting driving signals according to the video signals. The driving signals include the data signals and the gate signals. The power source 32 is connected to the controlling chip 31 and supplies power to the controlling chip 31. The power source 32 is connected to the driving module 20 via the FPCB 33 and supplies power to the driving module 20.

The signal transmitting module 40 includes an optical waveguide 41, a laser emitter 42, and a laser receiver 43. The optical waveguide 41 is an optical fiber, a thin film waveguide, or a strip waveguide. The optical waveguide 41 is configured for transmitting light signals. The wavelength of the optical signals transmitted in the optical waveguide 41 is from 0.8 micron to 1.6 micron. The attenuation of optical signals compared to electric signals is lower, the frequency band of the optical signals is wider, and the anti-interference qualities of the optical signals are better. In this embodiment, the optical waveguide 41 is inserted in the FPCB 33 and the frequency band of the optical waveguide 41 is about 10 Gbs.

The laser emitter 42 is connected between the controlling chip 31 and one end of the optical waveguide 41. The laser emitter 42 is configured for converting the driving signals (electrical signals) output from the controlling chip 31 to optical signals with a preset wavelength. The laser receiver 43 is connected between the other end of the optical waveguide 41 and the modem 50. The laser receiver 43 is configured for recovering the optical signals and reconverting them to the driving signals.

The modem 50 is connected between the laser receiver 43 and the driving module 20. The modem 50 is configured for dividing the driving signals output from laser receiver 43 into first driving signals and second driving signals and outputting the first driving signals to the source driving device 21 and the second driving signals to the grid driving device 22.

If the controlling chip 31 alternately outputs the driving signals corresponding to the first driving signals and then the driving signals corresponding to the second driving signals, the source driving device 21 receives the first driving signals at one time (first time) and the grid driving device 22 receives the second driving signals at another time (second time). The driving signal is not need to divide to the first driving signals and the second driving signals by the modem 50, and the modem 50 can be canceled from the LCD 100.

In use, the power source 32 supplies power to the source driving device 21 and the grid driving device 22 via the FPCB 33. The laser emitter 42 converts the driving signals output from the controlling chip 31 to the optical signals. The optical waveguide 41 transmits the optical signals from the laser emitter 42 to the laser receiver 43. The laser receiver 42 recovers and reconverts the optical signals into the driving signals and outputs the driving signals to the modem 50.

The modem 50 converts the driving signals to the first driving signals and the second driving signals and outputs the first driving signals to the source driving device 21 and the second driving signals to the grid driving device 22. The source driving device 21 outputs the data signals according to the first driving signals, and the date signals are output to the data lines DL. The grid driving device 22 outputs the gate signals according to the second driving signals and the gate signals are output to the gate lines GL. The liquid crystal units 11 are turned on or turned off by the date signals output from the data lines DL and the gate signals output from the gate lines GL. The LCD panel 10 is driven to display different images.

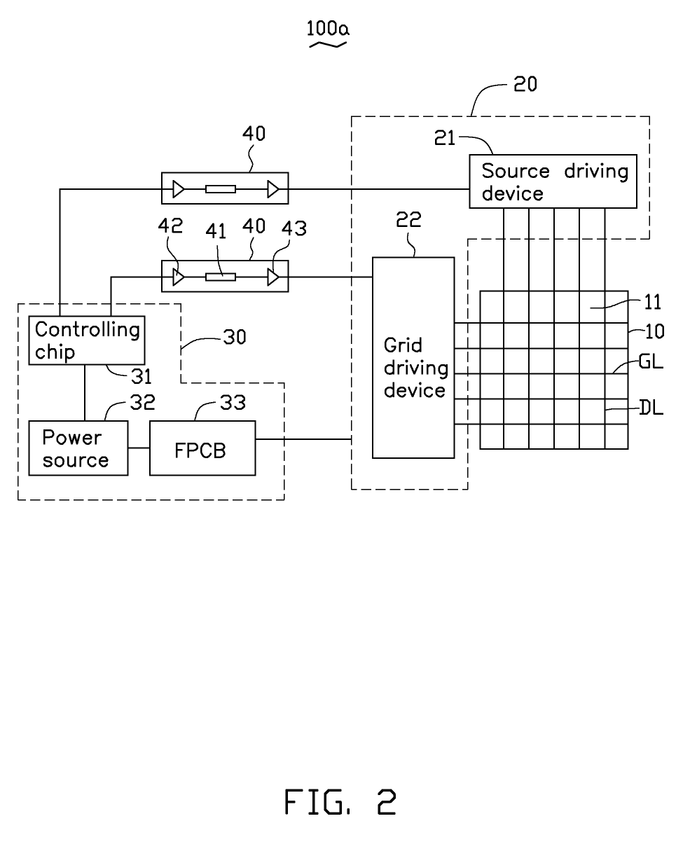

FIG. 2 is a LCD 100a, according to a second exemplary embodiment. The difference between the LCD 100a of the second exemplary embodiment and the LCD 100 of the first exemplary embodiment is that the LCD 100a includes two signal transmitting modules 40, but does not include the modem 50.

One of the signal transmitting modules 40 is connected between the controlling chip 31 and the source driving device 21, and the other signal transmitting module 40 is connected between the controlling chip 31 and the grid driving device 22. The controlling chip 31 outputs the first driving signals to the laser emitter 42 connected to the source driving device 21 and the second driving signals are output to the laser emitter 42 connected to the grid driving device 22.

As the driving signals are transmitted between the control chip 31 and the driving module 20 by the optical waveguide 41, the interference to the driving signals is reduced. Therefore, the LCD panel 10 can display an image with high quality.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A liquid crystal display (LCD), comprising:
an LCD panel;
a circuit module for outputting driving signals;
a driving module connected to the LCD panel for driving the LCD panel to display images according to the driving signals; and
a signal transmitting module comprising a laser emitter, an optical waveguide, and a laser receiver; the laser emitter connected between the circuit module and the optical waveguide for converting the driving signals to optical signals; the laser receiver connected between the optical waveguide and the driving module for recovering the optical signals to the driving signals.

2. The LCD of claim 1, wherein the LCD panel comprises a plurality of liquid crystal units, a plurality of gate lines, and a plurality of data lines; the liquid crystal units are arranged in an array; liquid crystal units arranged on a row are connected to one of the gate lines, and liquid crystal units arranged on a column are connected to one of the data lines.

3. The LCD of claim 2, wherein the driving module comprises a source driving device connected to the data lines and a grid driving device connected to the gate lines.

4. The LCD of claim 3, further comprising a modem connected between the laser receiver and the driving module, and the modem configured for dividing the driving signals to the first driving signals and the second driving signals and outputting the first driving signals to the source driving device and the second driving signals to the grid driving device.

5. The LCD of claim 4, wherein the source driving device outputs data signals according to the first driving signals, and the date signals are output to the data lines; the grid driving device outputs gate signals according to the second driving signals, and the gate signals are output to the gate lines.

6. The LCD of claim 3, further comprising another signal transmitting module, wherein one of the signal transmitting modules is connected between the controlling chip and the source driving device, and the other signal transmitting module is connected between the controlling chip and the grid driving device.

7. The LCD of claim 6, wherein the circuit module outputs first driving signals to the laser emitter of the signal transmitting module connected to the source driving device and second driving signals to the laser emitter of the other transmitting module connected to the grid driving device.

8. The LCD of claim 7, wherein the source driving device outputs data signals according to the first driving signals, and the date signals are output to the data lines; the grid driving device outputs gate signals according to the second driving signals, and the gate signals are output to the gate lines.

9. The LCD of claim 1, wherein the circuit module comprises a controlling chip, a power source, and a flexible printed circuit board (FPCB); the controlling chip is configured for outputting the driving signals; the power source supplies power to the driving module via the FPCB.

10. The LCD of claim 9, wherein the optical waveguide is inserted in the FPCB.
